(19) United States
(12) Patent Application Publication
(10) Pub. No.: US 2025/0059787 A1
(43) Pub. Date: Feb. 20, 2025

(54) SPECIALIZED CLEANING SYSTEM FOR CLEANING HARD FLAT VERTICAL SURFACES

(71) Applicant: WCB ROBOTICS INC., Dover, DE (US)

(72) Inventors: Ujjawal Aggarwal, Lucknow, Uttar Pradesh (IN); Yash Pandya, Dungarpur, Rajasthan (IN)

(21) Appl. No.: 18/710,868

(22) PCT Filed: Nov. 23, 2022
(86) PCT No.: PCT/IN2022/051022

§ 371 Date: May 16, 2024

(30) Foreign Application Priority Data
Nov. 23, 2021 (IN) 202141054021

(51) Int. Cl. E04G 23/00; B08B 1/12; B08B 1/16; B08B 1/40; B08B 3/02

(52) U.S. Cl. CPC E04G 23/004; B08B 1/12; B08B 1/16; B08B 1/40; B08B 3/024; B08B 2203/0229; B08B 2203/027

(57) ABSTRACT

A specialized cleaning system for cleaning hard flat vertical surfaces. The specialized cleaning system includes a cleaning brush with an integrated water dispenser, a wiper with an integrated water collector, a separator which separates water from a mixture of water and air that was sucked in, multiple pumps, an optional filter and a water storage tank. As the novel cleaning system and process uses a combination of a water reservoir and a suction pump, the spilling or running of water is prevented. Further, this also allows the system to work in both the direction e.g., from top to bottom of a high-rise building or from bottom to top of the building. Also, the process is a cyclic process i.e. the water from the reservoir is reused in every cycle of the operation.

### RELATED PATENT APPLICATION(S)

This application claims the priority to and benefit of Indian Provisional Patent Application No. 202141054021 filed on Nov. 23, 2021; the disclosures of which are incorporated herein by reference.

### FIELD OF THE INVENTION

The present invention relates to the field of cleaning system and equipment. More particularly the present invention relates to specialized cleaning system for cleaning hard surfaces which is a vertically moving cleaning machine especially applicable to the outer walls of high-rise buildings. The invention is in particular addressed to a system for cleaning hard flat vertical surfaces or sloped surfaces in both the directions i.e. from top to bottom and bottom to top.

### BACKGROUND OF THE INVENTION

In today's developed world, with the ever increasing number of the large windowed skyscrapers, the demand for their maintenance is also on the rise. The outer walls of such skyscrapers are usually made of materials such as stone, glass, metal tile, wooden tile, etc. The dust, acid, salt, etc. present in the environment contaminates the outer wall of the skyscrapers as the period elapses. Therefore, regular cleaning work is performed on the exterior wall of the skyscrapers to maintain the beauty and cleanliness of the exterior of the skyscrapers.

Traditionally, the cleaning is done by manual labor which is expensive and has high liability.

Many robotic solutions have also been developed to overcome this problem. The following prior arts disclose a similar machines to clean the skyscrapers.

US patent publication no. U.S. Pat. No. 8,661,598B2 discloses a machine to clean facade of building. The apparatus disclosed uses a fabric cloth to clean the surface and then cleans the fabric using an in-build laundering unit. The fabric is then reused. A system like this can get extremely heavy due to the large amount of fabric and the complex in-built laundering system. Hence, it is unsuitable for attachment to a lightweight robotic system.

Another US publication No. U.S. Pat. No. 5,465,446A discloses a high-rise building cleaning machine. This machine uses car-wash like brushes to clean the building but does not have any method to wipe the surface and completely remove the water from the surface. Hence this system will use very large amount of water and face water spillage problems.

### Limitations of the Prior Art

The major drawbacks of the available prior art are that they cause water spillage i.e. dirty water flows from the top of the skyscrapers. Since, the dirty water flows from top of the building as the machine can only clean the surface from top to bottom. Also, these systems often use large quantities of deionized water with the brush. Other prior art may be too heavy and limit its application to suspended robots and not in suction based robots.

Thus, to overcome the said drawbacks, the present invention provided a novel specialized cleaning system for cleaning hard flat vertical surfaces along with the process that can easily be deployed in specialized robotic systems and clean the high-rise building. Further, the invention is in particular addressed to a system for cleaning hard flat vertical surfaces or sloped surfaces in both the directions i.e. from top to bottom and bottom to top.

### OBJECTS OF THE INVENTION

The primary objective of the present invention is to provide specialized robotic cleaning system for cleaning hard flat vertical surfaces.

Another objective of the present invention is to provide a novel process suitable for specialized lightweight robotic cleaning systems for cleaning hard flat vertical surfaces.

Another objective of the present invention is to provide a specialized cleaning process and system that makes the most use of water and avoids spillage.

Another objective of the present invention is to provide a system which is able to clean in both directions, bottom to top and top to bottom.

Another objective of the present invention is to provide a cleaning process and system which conservers water by using it very effectively and uses traditional inexpensive detergent water instead of expensive deionized water.

Yet a further objective of the present invention is to provide a specialized robotic cleaning system that can carry the required water on board without increasing the weight too much instead of needing a running supply of water. Water recycling ability described in the system allows small quantity of onboard water to clean a very large surface.

### SUMMARY OF THE INVENTION

Accordingly, the present invention provides a specialized robotic cleaning system for cleaning hard flat vertical surfaces. Further, the present invention also provides a novel process suitable for specialized lightweight robotic cleaning systems for cleaning hard flat vertical surfaces. The said specialized cleaning process and system makes the most use of water and avoids spillage and is able to clean in both directions i.e. from bottom to top and top to bottom.

Further, the provided cleaning process and system conservers water by using it in a very effective way and uses traditional inexpensive detergent water instead of expensive deionized water. Also, the provided specialized robotic cleaning system can carry the required water on board without increasing the weight too much instead of needing a running supply of water. Water recycling ability described in the system allows small quantity of onboard water to clean a very large surface.

In one aspect of the present invention, the invention provides a specialized cleaning system (100) for cleaning hard flat vertical surfaces, wherein the system (100) comprises:
a reservoir (1) to stores water for the cleaning purpose;
a pump/pumps (2) for pumping water from the reservoir (1) for the cleaning purpose;
an in brush dispenser (3) for dispensing or spraying the water on the hard vertical surface which is to be cleaned;
a brush (4) for dispensing a cleaning fluid onto the hard surface and scrubbing the cleaning solution on the hard surface and agitating the dirt;
a wiper (5) for wiping the hard flat surface;
a wiper integrated suction (6) for sucking the contaminated or dirty water in to avoid the spillage or running of water down the building;
a separator (7) for taking in the air-water mixture sucked from the surrounding and separating the air from the mixture;
an optional filter (8) for separating dust from the dirty water;
a pump (9) for pumping cleaned water back into the reservoir (1); and
a suction pump (10) mounted in the system (100) which sucks the air from the separator (7) and exhausts the air in the atmosphere through an exhaust (11);
wherein the filtered water can be reused and is mixed with the clean unused water in the water reservoir (1), and
wherein the system (100) works in both the direction i.e. from top to bottom of the high-rise building or from bottom to top of the building.

The pump (2) is a peristaltic pump.

The brush (4) and the wiper (5) are attached using a compliant arm.

The cleaning fluid often comprises water-detergent solution.

The wiper (5) is a vacuum squeegee apparatus.

The separator (7) takes in the air-water mixture sucked from the surrounding and separates the air from the mixture and to suck dirty water and air through the system (100) a low pressure is created in the system (100) by employing the sucking pump (10).

The water recycling ability of the system (100) allows small quantity of onboard water to clean a very large surface.

The system (100) is a lightweight cleaning system and a small amount of water helps the robotic system to carry the required water on board without increasing weight or needing a running water supply.

In another aspect of the present invention, the invention provides a process of specialized cleaning system (100) for cleaning hard flat vertical surfaces, wherein the process comprises the steps of:
a. dispensing water from the reservoir (1) using a pump/pumps (2);
b. scrubbing the surface to be cleaned using a brush (4);
c. wiping the dirty water using wipers (5);
d. sucking the dirty water in wiper integrated suction (6);
e. separating the water from the air using a separator (7) and exhausting out air using an exhaust (11);
f. filtering the dirty water separated from the air using a filter (8) (optional) and
g. pumping and mixing the clean water by pump (9) again in the reservoir (1) for next cycle.
wherein the said process of the system (100) works in both the direction i.e. from top to bottom of the high-rise building or from bottom to top of the building.

The said process is a cyclic process i.e. the water from the reservoir (1) is reused in every cycle of the operation.

The above description merely is an outline of the technical solution of the present disclosure. The summary is descriptive and exemplary only and is not intended to be in any way restricting. In order to know the technical means of the present disclosure more clearly so that implementation may be carried out according to contents of the specification, and in order to make the above and other objectives, characteristics and advantages of the present disclosure more clear and easy to understand, specific embodiments of the present invention will be described in detail below.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in line diagram form in order to avoid unnecessarily obscuring the embodiments of the invention. In the drawings:

FIG. 1 shows the flow chart of the system (100) and process of the specialized cleaning system.

### DETAILED DESCRIPTION OF THE INVENTION

Accordingly, the present application discloses a specialized cleaning system for cleaning hard flat vertical surfaces. The available prior arts cleaning system do not makes complete use of the water. The available cleaning system do not use the water effectively and do not conserve the water. Also, the available systems uses expensive deionized water.

Further, the major drawbacks of the available prior art are that they cause water spillage i.e. dirty water flows from the top of the skyscrapers. Since, the dirty water flows from top of the building as the machine can only clean the surface from top to bottom. Also, these systems often use large quantities of deionized water with the brush. Other prior art may be too heavy and limit its application to suspended robots and not in suction based robots.

Thus, to overcome the said drawbacks, the present invention provided a novel specialized cleaning system for cleaning hard flat vertical surfaces along with the process that can easily be deployed in specialized robotic systems and clean the high-rise building. Further, the invention is in particular addressed to a system for cleaning hard flat vertical surfaces in both the directions i.e. from top to bottom and bottom to top.

Accordingly, in one aspect the present invention provides a specialized robotic cleaning system for cleaning hard flat vertical surfaces. In another aspect of the present invention, the present invention also provides a novel process suitable for specialized lightweight robotic cleaning systems for cleaning hard flat vertical surfaces.

The said specialized cleaning process and system makes the most use of water and avoids spillage and is able to clean in both directions i.e. from bottom to top and top to bottom.

Further, the provided cleaning process and system conservers water by using it in a very effective way and uses traditional inexpensive detergent water instead of expensive deionized water. Also, the provided specialized robotic cleaning system can carry the required water on board without increasing the weight too much instead of needing a running supply of water. Water recycling ability described in the system allows small quantity of onboard water to clean a very large surface.

In one aspect of the present invention, the cleaning system comprises a cleaning brush with an integrated water dispensing, a wiper with an integrated water collection, a separator which separates the water from the mixture of water and air that was sucked in, multiple pumps, an optional filter and a water storage tank.

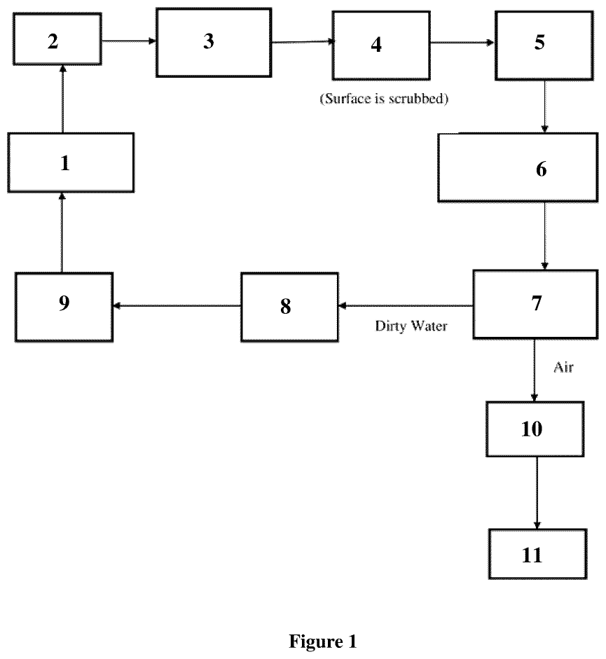

Referring to FIG. 1 of the present invention, it discloses flow chart of the system and process of the cleaning system. All the components used in the system (100) are defined by using blocks. Thus, the present invention comprises of a cleaning system (100) comprising a reservoir (1), two pumps denoted by (2 and 9), an in brush dispenser (3), a brush (4), a wiper (5), a wiper integrated suction block (6), separator (7), an optional filter (8), a suction pump (10) and an exhaust (11).

All the components of the system (100) are interconnected with one another using multiple pipes and other supporting component which are not explicitly shown in the FIGURE.

The system (100) comprises a reservoir or a storage tank denoted by block 1. The said reservoir (1) stores the water for the cleaning purpose. The working of the said system (100) is a cyclic process. The process starts with suction of water from the reservoir (1) by the pump (2) and ends with returning the water to the reservoir (1) by the pump (9). Both the pumps and their functions will be defined here later. The said reservoir (1) is a storage tank that stores water for the cleaning the hard flat surface using the said system (100). The provided cleaning process and system conservers water by using it in a very effective way which is achieved by the said reservoir (1).

The provided specialized robotic cleaning system can carry the required water on board without increasing the weight too much instead of needing a running supply of water. Water recycling ability described in the system allows small quantity of onboard water to clean a very large surface.

The system further comprises a pump (2) for pumping water from the reservoir (1) for the cleaning purpose. Any available pump can be used in the system (100) for pumping water out of the reservoir (1). In one preferred embodiment, the pump (2) is a peristaltic pump. The pump (2) establishes the connection between the reservoir (1) and an in brush dispenser (3) through pipes (not shown the FIGURE). The In Brush Dispenser is denoted by block (3) in the FIGURE. The main purpose of the in brush dispenser (3) is to dispense or spray the water on the hard vertical surface which is to be cleaned. It is preferable to use an in-brush dispenser (3) instead of a spraying system as the only way the water escapes this closed system is through evaporation and thus evaporation should be minimized.

Further, the system comprises of a brush (4). In one embodiment, the brush (4) that may be used in the above system is a specialized cleaning brush. In one preferred embodiment, the said brush (4) is a cleaning brush similar to one developed by present Applicant in another invention titled “SPECIALIZED SCRUBBING BRUSH FOR CLEANING HIGH RISE WINDOWS AND OTHER HARD SURFACES” which directly dispenses the cleaning fluid into the scrubbing pad, which is incorporated herein for reference. The brush (4) dispenses cleaning fluid onto the hard surface. This cleaning fluid often comprises water-detergent solution. The brush (4) scrubs the cleaning solution on the hard surface and agitating the dirt.

After the brush (4) scrubs the cleaning solution the hard surface and agitating the dirt, the surface is then wiped with a wiper (5). The brush (4) and wiper (5) should be attached using a compliant arm (not shown). This arm acts like a suspension system of a car and maintains cleaning force while working with variations in a surface. The wiper (5) is specially designed and has an integrated dirty water suction (6). Preferred embodiment has a vacuum squeegee like apparatus as the wiper (5). The main purpose of the integrated suction (6) is to sucks the contaminated or dirty water in, to avoid the spillage or running of water down the building. The water suction system inevitably sucks in surrounding air along with the water on the dirty surface.

An air water separator (7) is mounted in the system (100). The main purpose of the separator (7) is to takes in the air-water mixture sucked from the surrounding and separates the air from the mixture. One of the best methods to suck dirty water and air through the system (100) is to create a low pressure in the system (100). To perform the same, a suction pump (10) is mounted in the system (100) which sucks the air from the separator (7) and exhausts the air in the atmosphere using an exhaust (11). Thus, the exhaust air from separator (7) must go through a pump (10) before being exhausted into atmosphere.

Further, filters (8) can be optionally mounted in the system (100). The dirty water that collects in the separator (7) is pumped through the filter (8) that separates dust from the water. The filtered water can be reused and hence is mixed with the clean unused water in the water reservoir (1) using pump (9). Mounting of filter (8) is an optional feature of the present invention. In one aspect of the present invention, the system does not comprise a filter.

Thus, the above system (100) can be summarized as a specialized cleaning system (100) for cleaning hard flat vertical surfaces, wherein the system comprises:
a reservoir (1) to stores the water for the cleaning purpose;
a pumps (2) for pumping water from the reservoir (1) for the cleaning purpose;
an in brush dispenser (3) for dispensing or spraying the water on the hard vertical surface which is to be cleaned;
a brush (4) for dispensing a cleaning fluid onto the hard surface and scrubbing the cleaning solution on the hard surface and agitating the dirt. The brush being preferably mounted on a compliant arm;
a wiper (5) for wiping the hard flat surface, the wiper being preferably mounted on a compliant arm;
a wiper integrated suction (6) for sucking the contaminated or dirty water in to avoid the spillage or running of water down the building;
a separator (7) for taking in the air-water mixture sucked from the surrounding and separating the air from the mixture;
an optional filter (8) for separating dust from the water;
a pump (9) for pumping clean water back into the reservoir (1); and
a suction pump (10) mounted in the system (100) which sucks the air from the separator (7) and exhausts the air in the atmosphere through an exhaust (11);
   wherein the filtered water can be reused and is mixed with the clean unused water in the water reservoir (1), and
   wherein the system (100) works in both the direction i.e. from top to bottom of the high-rise building or from bottom to top of the building.

In another aspect of the present invention, the present invention further disclose a novel process of the specialized cleaning system for cleaning hard flat vertical surfaces. The process of the present comprises of the following steps:

Step 1: Dispensing Water from the Reservoir Using a Pump/Pumps;
In step 1, the water from the reservoir (1) is dispensed onto the flat hard surface using the pump (2). The water is sucked from the reservoir (1) using pump (1) and sprayed on the hard surface. It is preferable to use an in-brush dispenser instead of a spraying system as the only way the water escapes this closed system is through evaporation and thus evaporation should be minimized.

### Step 2: Scrubbing the Surface to be Cleaned Using a Brush;

In step 2, the hard flat surface is scrubbed using the brush (4) along with the dispensed water dispensed by the in brush dispenser (3) in step 1.

Step 3: Wiping the dirty water using wipers;

Once the brush (4) scrubs the cleaning solution the hard surface and agitating the dirt, the surface is then wiped with a wiper (5).

### Step 4: Sucking the Dirty Water in Wiper Integrated Suction;

After the completion of step 4, the specially designed wiper (5) with an integrated dirty water suction (6) sucks the dirty water. Preferred embodiment has a vacuum squeegee like apparatus as the wiper (5). The main purpose of the integrated suction (6) is to sucks the contaminated or dirty water in to avoid the spillage or running of water down the building. The water suction system inevitably sucks in surrounding air along with the water on the dirty surface.

Step 5: Separating the Water from the Air Using a Separator and Exhausting Out Air using an exhaust;

The separator (7) takes in the air-water mixture sucked from the surrounding and separates the air from the mixture. A suction pump (10) mounted in the system (100) sucks the air from the separator (7) and exhausts the air in the atmosphere using an exhaust (11).

Step 6: Filtering the Dirty Water Separated from the Air Using a Filter (Optional)

The dirty water that collects in the separator (7) is pumped through the filter (8) that separates dust from the water.

### Step 7: Pumping and Mixing the Clean Water Again in the Reservoir for Next Cycle.

The filtered water can be reused and hence is mixed with the clean unused water in the water reservoir (1) using pump (9). Since the separator interior is at a lower pressure than the pressure in the water reservoir, a pump is needed even if the filter (optional) is not present. The pump is especially needed if the filter is present to force water through the filter.

Thus, the above described novel process of the specialized cleaning system for cleaning hard flat vertical surfaces can be summarized as:
Step 1: Dispensing water from the reservoir using a pump/pumps;
Step 2: Scrubbing the surface to be cleaned using a brush;
Step 3: Wiping the dirty water using wipers;
Step 4: Sucking the dirty water in wiper integrated suction;
Step 5: Separating the water from the air using a separator and exhausting out air using an exhaust;
Step 6: Filtering the dirty water separated from the air using a filter (optional)
Step 7: Pumping and mixing the clean water again in the reservoir for next cycle.

As the said novel cleaning system and process uses a combination of water reservoir and suction pump, the spilling or running of water is prevented. Further, this also allows the system to work in both the direction i.e. from top to bottom of the high-rise building or from bottom to top of the building.

### Advantages:

The said cleaning system of the present invention is able to clean the surfaces in both the direction i.e. top to bottom and bottom to top.
The cleaning system recycles the water used and again use the same for next cycle. Thus, the process makes the most use of the water in very effective and conservative way and avoids spillage.
The system uses traditional inexpensive detergent water instead of expensive deionized water.
The small amount of water used helps the robotic system to carry the required water on board without increasing weight or needing a running water supply. This makes this system especially useful for use on lightweight cleaning robots.

1. A specialized cleaning system for cleaning hard flat vertical surfaces, wherein the system comprises:
a reservoir to store a cleaning fluid comprising water for cleaning;
a first pump for pumping cleaning fluid from the reservoir for cleaning;
an in brush dispenser for dispensing or spraying the cleaning fluid on the hard flat vertical surface which is to be cleaned;
a brush for dispensing the cleaning fluid onto the hard flat vertical surface and scrubbing the cleaning fluid on the hard flat vertical surface and agitating dirt;
a wiper for wiping the hard flat vertical surface;
a wiper integrated suction for sucking contaminated or dirty cleaning fluid in to avoid spillage or running of cleaning fluid down the hard flat vertical surface;
a separator for taking in an air-water mixture sucked by the wiper integrated suction from and separating the air from the contaminated or dirty water contained in the mixture;
a filter for filtering the contaminated or dirty water to produce a filtered cleaning fluid;
a second pump for pumping the filtered cleaning fluid back into the reservoir; and
a suction pump mounted in the system which sucks the air from the separator and exhausts the air in the atmosphere through an exhaust;
wherein the reservoir is arranged to mix the cleaned cleaning fluid with the cleaning liquid in the reservoir, and
wherein the system is operable in direction from a top to a bottom of the hard flat vertical surface and in a direction from the bottom to the top of the hard flat vertical surface.

2. The specialized cleaning system as claimed in claim 1, wherein the first pump is a peristaltic pump.

3. The specialized cleaning system as claimed in claim 1, wherein the brush and the wiper are attached by a compliant arm.

4. The specialized cleaning system as claimed in claim 1, wherein the cleaning fluid comprises a water-detergent solution.

5. The specialized cleaning system as claimed in claim 1, wherein the wiper is a vacuum squeegee apparatus.

6. The specialized cleaning system as claimed in claim 1, wherein the separator is arranged to take in the air-water mixture and separate the air from the mixture and to suck the contaminated or dirty water and the air through the system at a low pressure in the system by employing the suction pump.

7. (canceled)

8. The specialized cleaning system as claimed in claim 1, wherein the system lacks a running water supply.

9. A process of operating a specialized cleaning system for cleaning a hard flat vertical surface, wherein the process comprises:
a. dispensing a cleaning fluid from the reservoir using a first pump;
b. scrubbing the surface to be cleaned using a brush;
c. wiping dirty cleaning fluid using a wiper;
d. sucking the dirty cleaning fluid in with a wiper integrated suction;
e. separating the dirty cleaning fluid from air using a separator and exhausting out the air using an exhaust;
f. filtering the dirty cleaning fluid separated from the air using a filter to produce a filtered cleaning liquid; and
g. pumping and mixing the filtered cleaning liquid by a pump to the reservoir for a next cycle,
wherein the said process of operating the system is operable in both in a direction from a top of the surface to a bottom of the surface and in a direction from the bottom of the surface to the top of the surface.

10. The process as claimed in claim 9, wherein the process is a cyclic process in which the cleaning fluid from the reservoir is reused in every cycle of the operation.
